(19) United States
(12) Patent Application Publication
(10) Pub. No.: US 2023/0312408 A1
(43) Pub. Date: Oct. 5, 2023

(54) LOW-EMISSIVITY MATERIAL WITH HIGH SELECTIVITY AND GLAZING COMPRISING SUCH A MATERIAL

(71) Applicant: SAINT-GOBAIN GLASS FRANCE, COURBEVOIE (FR)

(72) Inventors: Corentin MONMEYRAN, PARIS (FR); Vinicius Antonio DA SILVA BALANI, SAO JOSE DOS CAMPOS (BR)

(21) Appl. No.: 18/042,957

(22) PCT Filed: Aug. 10, 2021
(86) PCT No.: PCT/FR2021/051458

§ 371 Date: Feb. 24, 2023

(30) Foreign Application Priority Data
Aug. 27, 2020 (FR) FR2008729

(51) Int. Cl. C03C 17/36; C03C 17/34; C03C 3/087

(52) U.S. Cl. CPC C03C 17/3636; C03C 17/3435; C03C 17/3607; C03C 17/3626; C03C 17/3644; C03C 17/3652; C03C 17/366; C03C 17/3681; C03C 3/087; C03C 2217/74

(57) ABSTRACT

A material includes a transparent substrate coated with a stack including at least one silver-based functional metallic layer and at least two dielectric coatings, each dielectric coating including at least one dielectric layer, so that each functional metallic layer is positioned between two dielectric coatings, wherein the stack includes two blocking layers located in contact, below and above, with a silver-based functional metallic layer, the blocking layers being chosen from metallic layers based on a metal or a metal alloy of one or more elements chosen from titanium, nickel, chromium, tantalum, zirconium and niobium, and a titanium nitride layer located in contact with a blocking layer and separated from the silver-based functional layer by the blocking layer.

The invention relates to a material comprising a transparent substrate coated with a functional coating such as a stack comprising a silver-based functional metallic layer. The invention also relates to the glazing comprising these materials and also to the use of such materials for manufacturing thermal insulation and/or solar protection glazings.

In the following description, the term “functional” as used in “functional coating” means “able to act on solar radiation and/or infrared radiation.”

These glazings are intended to equip either buildings or vehicles, especially in order to:
reduce climate control effort and/or prevent excessive heating, glazings so-called “solar control,” and/or
reduce the amount of energy dissipated to the exterior, glazings so-called “low-emissivity.”

The solar control glazings are subjected to a certain number of constraints.

The functional coatings must be sufficiently filtering with respect to solar radiation and especially with respect to the part of the non-visible solar radiation located between about 780 nm and 2500 nm, usually called solar infrared (solar IR), while allowing as much visible light to pass through as possible.

The selectivity “S” enables the performance of these glazings to be evaluated. It corresponds to the ratio of light transmission TLᵥᵢₛ in the visible range of the glazing to the solar factor FS of the glazing (S=TLᵥᵢₛ/FS). Solar factor “FS or g” is understood to mean the ratio in % of the total solar energy entering the premises through the glazing to the incident solar energy.

Functional coatings must also be sufficiently durable. In particular, they must be resistant to physical stresses such as scratches.

Silver-based functional metallic layers (or silver layers) have advantageous electrical conduction and infrared radiation (IR) reflection properties. Such layers are therefore used in solar-control or low-emissivity glazings.

The stacks comprising silver-based functional metallic layers (or silver layers) especially have the best performance for increasing the selectivity of the glazings while retaining optical and aesthetic qualities.

These silver layers are deposited between coatings based on dielectric materials, which generally comprise several dielectric layers (hereinafter “dielectric coatings”), making it possible to adjust the optical properties of the stack. Interference effects are used to adjust the colors of the materials. Furthermore, these dielectric layers make it possible to protect the silver layer from chemical or mechanical attacks.

However, the chemical and thermal resistance and mechanical strength of the coatings comprising these silver-based functional metallic layers is often insufficient.

Their low resistance/strength makes it difficult to use them in simple glazings. These silver-based coatings are not sufficiently robust when exposed to climate conditions, cleaning, and therefore mechanical attacks.

Moreover, depending on the intended applications, certain materials must undergo heat treatments, intended to improve the properties of the substrate and/or of the stack of thin layers. In the case of glass substrates, these may for example be thermal tempering treatments intended to mechanically strengthen the substrate by creating strong compressive stresses at its surface.

However, high-temperature heat treatments such as annealing, bending and/or tempering cause modifications within the silver layer. They generally make the stacks more sensitive to scratches. Furthermore, when scratches are created on a material before heat treatment, their visibility considerably increases after heat treatment.

This low resistance is reflected, during use under normal conditions, in the appearance in the short term of defects such as corrosion points, scratches, or even the total or partial tearing away of the stack. This phenomenon is accentuated when these glazings are subjected to a high-temperature heat treatment.

All defects or scratches, whether due to corrosion or mechanical stresses, are liable to affect not only the energy and optical performance of the coated substrate, but also the appearance thereof.

The invention very particularly relates to materials comprising a substrate coated with a stack, having a high selectivity. However, it remains essential that the advantageous selectivity properties are obtained without harming:
the mechanical strength, in particular the scratch and brush resistance, preferably, whether or not the material has undergone a high-temperature heat treatment, and
the corrosion resistance.

The optical and electrical properties of the materials depend directly on the quality of the silver layers such as their crystalline state, their homogeneity and their environment. The term “environment” is understood to mean the nature of the layers in the vicinity of the silver layer and the surface roughness of the interfaces with these layers.

In the range of silver-based stacks, there is a wide range of configurations depending on the desired performance.

To improve the adhesion of the silver layers and to reduce the chemical interactions with the neighboring layers, it is known to use fine layers called blocking layers in direct contact with the silver layer. Blocking layers are generally based on a metal chosen from nickel, chromium, titanium, niobium or an alloy of these various metals. The various metals or alloys cited may also be partially oxidized, and may especially be oxygen substoichiometric (for example TiOx or NiCrOx).

These blocking layers are very thin, normally with a thickness of less than 3.5 nm and are likely to be partially oxidized during a heat treatment. In general, these blocking layers are sacrificial layers capable of capturing oxygen coming from the atmosphere or from the substrate, thus preventing the silver film from oxidizing.

For high-end products, stacks comprising a plurality of silver-based layers are used. The silver layers are surrounded by other layers which improve the quality of the silver layer and therefore the performance of the material. In particular, dielectric layers having a stabilizing function intended to promote wetting and nucleation of the silver layer are known in contact above and below the silver layers. Dielectric layers based on crystalline zinc oxide are in particular used for this purpose.

However, layers based on crystalline zinc oxide are “fragile” layers which make the stack more sensitive to scratches and corrosion.

When robustness is a key characteristic for the intended application, it is possible to use a single silver layer and not to use a layer based on zinc oxide. By proceeding in this way, the robustness, processability and lifespan of the coating are greatly improved.

On the other hand, the blocking layers cannot be removed without making the stack too sensitive to scratching to be treated industrially.

To date, the best results in terms of robustness were obtained with a material not comprising crystalline zinc oxide and each dielectric coating of which comprises at least one layer comprising silicon. The silver layer is located in contact with the two blocking layers located above and below the silver layer, respectively. Materials of this type comprising the sequence SiN/NiCr/Ag/NiCr/SiN are described as reference material in the present application.

However, the use of the blocking layers alone does not make it possible to obtain materials that are sufficiently robust and effective, especially having a sufficiently high selectivity. Indeed, these blocking layers are not selective and absorb visible and infrared light alike. These blocking layers do not have a positive influence on the energy performance of the material.

The present invention remedies these drawbacks. The applicant has developed a material comprising a substrate coated with a stack, having high selectivity without harming:
the mechanical strength, especially the scratch and brush resistance, preferably, whether or not the material has undergone a high-temperature heat treatment, and
the corrosion resistance.

The invention thus relates to a material comprising a transparent substrate coated with a stack comprising at least one silver-based functional metallic layer and at least two dielectric coatings, each dielectric coating including at least one dielectric layer, so that each functional metallic layer is positioned between two dielectric coatings, characterized in that the stack comprises:
two blocking layers located in contact, below and above, with a silver-based functional metallic layer, the blocking layers are chosen from metallic layers based on a metal or a metal alloy of one or more elements chosen from titanium, nickel, chromium, tantalum, zirconium and niobium,
a titanium nitride layer located in contact with a blocking layer and separated from the silver-based functional layer by said blocking layer.

The particular sequence of the invention Ag/blocking layer/TiN or TiN/blocking layer/Ag has the advantage, compared to the use of a mere blocking layer, of offering the best compromise in terms of selectivity, emissivity, and mechanical and chemical durability. Indeed, the selectivity and emissivity of the materials according to the invention are both better than those obtained with reference materials, while retaining high mechanical and chemical durability.

The solution of the invention therefore makes it possible to improve energy performance without degrading scratch resistance and without increasing the complexity of the stack.

According to an advantageous embodiment, the dielectric coatings enclosing the functional layer consist essentially of layers comprising silicon and/or aluminum.

The invention also relates:
to a glazing comprising a material according to the invention,
to a glazing comprising a material according to the invention mounted on a device, on a vehicle, especially a motor vehicle, or on a building, and
to the process for preparing a material or a glazing according to the invention,
to the use of a glazing according to the invention as solar-control and/or low-emissivity glazing for buildings or vehicles,
to a building, vehicle or device comprising a glazing according to the invention.

The glazing of the invention is also suitable for all applications requiring the use of a stack comprising silver layers for which mechanical strength and corrosion resistance are key parameters.

The material according to the invention can be in the form of a monolithic, laminated and/or multiple glazing, in particular double glazing or triple glazing.

Throughout the description, the substrate according to the invention is regarded as laid horizontally. The stack of thin layers is deposited above the substrate. The meaning of the expressions “above” and “below” and “lower” and “upper” is to be considered with respect to this orientation. Unless specifically stipulated, the expressions “above” and “below” do not necessarily mean that two layers and/or coatings are positioned in contact with one another. When it is specified that a layer is deposited “in contact” with another layer or with a coating, this means that there cannot be one (or more) layer(s) inserted between these two layers (or layer and coating).

All the light characteristics presented in the description are obtained according to the principles and methods described in the European standard EN 410 relating to the determination of the light and solar characteristics of the glazings used in glass for the construction industry. It is considered that the sunlight entering a building goes from the outside to the inside.

According to the invention, the light characteristics are measured according to the D65 illuminant at 2° perpendicular to the material mounted in a double glazing:
TL corresponds to light transmission in the visible range in %,
Rext corresponds to the exterior light reflection in the visible range in %, observer on the exterior space side,
Rint corresponds to the interior light reflection in the visible range in %, observer on the interior space side,
a*T and b*T correspond to the colors in transmission a* and b* in the L*a*b* system,
a*Rext and b*Rext correspond to the colors in reflection a* and b* in the L*a*b* system, observer on the exterior space side,
a*Rint and b*Rint correspond to the colors in reflection a* and b* in the L*a*b* system, observer on the interior space side.

The preferred characteristics which appear in the remainder of the description are applicable both to the material according to the invention and, where appropriate, to the glazings, devices or method according to the invention.

The material, that is the transparent substrate coated with the stack, may be intended to be subjected to a high-temperature heat treatment. Consequently, according to this embodiment, the stack and the substrate have preferably been subjected to a high-temperature heat treatment such as tempering, annealing or bending.

The stack is deposited by magnetic-field-assisted cathode sputtering (magnetron method). According to this advantageous embodiment, all the layers of the stack are deposited by magnetic-field-assisted cathode sputtering.

Unless otherwise mentioned, the thicknesses alluded to in the present document are physical thicknesses and the layers are thin layers. Thin layer is understood to mean a layer having a thickness of between 0.1 nm and 100 micrometers.

The stack comprises at least one titanium nitride layer located in contact with a blocking layer.

The titanium nitride layer may be located above or below the silver-based functional layer, preferably above.

Preferably, the titanium nitride layers are based on titanium nitride or even more preferably consist substantially of titanium nitride.

Titanium-based layers according to the invention comprise for example more than 50% by mass of titanium nitride, more than 80% by mass, more than 90% by mass or even more than 95% by mass of titanium nitride.

The titanium nitride according to the invention is not necessarily stoichiometric (Ti/N atomic ratio of 1) but can be over- or under-stoichiometric. According to one advantageous embodiment, the N/Ti ratio is between 1 and 1.2. Also, the titanium nitride according to the invention can comprise a minor amount of oxygen, for example between 1 and 10 mol. % oxygen, especially between 1 and 5 mol. % oxygen.

According to a particularly preferred embodiment, the titanium nitride layers according to the invention have the general formula TiNₓO_{y}, in which 1.00<x<1.20 and in which 0.01<y<0.10.

The titanium nitride-based layer may comprise at least 50%, at least 60%, at least 70%, at least 80%, at least 95.0%, at least 96.5%, at least 98.0%, or at least 99.0% by mass of titanium compared to the mass of all elements forming the titanium nitride-based layer other than nitrogen or oxygen.

The titanium nitride-based layer may comprise or consist of elements other than titanium and nitrogen. These elements may be selected from silicon, chromium, hafnium and zirconium. Preferably, the elements are chosen from zirconium. Preferably, the titanium nitride-based layer comprises not more than 40%, not more than 35%, not more than 20%, or not more than 10% by mass of elements other than titanium compared to the mass of all elements forming the titanium nitride-based layer other than nitrogen.

The titanium nitride-based layer may have a thickness:
greater than or equal to 2 nm, greater than or equal to 2 nm, greater than or equal to 3 nm, greater than or equal to 4 nm, greater than or equal to 5 nm, and/or
less than or equal to 20 nm, less than or equal to 18 nm, less than or equal to 15 nm, less than or equal to 12 nm.

The titanium nitride layer preferably has a thickness of between 5 and 15 nm.

The titanium nitride-based layer can be obtained by cathode sputtering from a metal target of titanium in an atmosphere comprising nitrogen.

The silver-based functional metallic layer comprises, before or after heat treatment, at least 95.0%, preferably at least 96.5% and better still at least 98.0% by weight of silver relative to the weight of the functional layer.

Preferably, the silver-based functional metallic layer comprises, before heat treatment, less than 5% or less than 1.0% by weight of metals other than silver, relative to the weight of the silver-based functional metallic layer.

The thickness of the silver-based functional layer is comprised between 5 to 25 nm, or from 7 to 16 nm.

Preferably, the stack of thin layers comprises just one functional layer. The stack of thin layers in this case comprises just one functional layer and two dielectric coatings comprising at least one dielectric layer, so that each functional layer is placed between two dielectric coatings. The stacks with a single silver layer are generally the most robust mechanically.

The stack of thin layers may comprise at least two silver-based functional metallic layers and at least three dielectric coatings comprising at least one dielectric layer, so that each functional layer is placed between two dielectric coatings.

The stack of thin layers may comprise at least three silver-based functional metallic layers and at least four dielectric coatings comprising at least one dielectric layer, so that each functional layer is placed between two dielectric coatings.

The stack is located on at least one of the faces of the transparent substrate.

The stack comprises two blocking layers located in contact, below and/or above the silver-based functional metallic layer.

The function of the blocking layers is to protect the silver layers by preventing possible damage related to the deposition of a dielectric coating or related to a heat treatment.

A blocking layer located above a silver-based functional metallic layer is referred to as blocking overlayer. A blocking layer located below a silver-based functional metallic layer is referred to as blocking underlayer.

The blocking layers are selected from metallic layers based on a metal or on a metal alloy of one or more elements selected from titanium, nickel, chromium, tantalum and niobium, such as Ti, Ta, Nb, Ni, Cr, NiCr.

These blocking layers deposited in metallic form can undergo a partial or complete oxidation according to their thickness and the nature of the layers which surround them, for example, during the deposition of the following layer or by oxidation in contact with the underlying layer.

The blocking layers may be selected from metallic layers, especially an alloy of nickel and chromium (NiCr) or of titanium.

Advantageously, the blocking layers are metallic layers based on nickel. The metal blocking layer based on nickel may comprise (before heat treatment) at least 20%, at least 30%, at least 40%, at least 50%, at least 60%, at least 70%, at least 80%, at least 90%, at least 95%, at least 96%, at least 97%, at least 98%, at least 99% or 100% by weight of nickel relative to the weight of the nickel-based metallic layer.

The nickel-based metallic layers may be selected from:
nickel metallic layers,
doped nickel metallic layers,
metallic layers based on a nickel alloy.

The metallic layers based on a nickel alloy can be based on a nickel-chromium alloy.

Each blocking layer has a thickness of between 0.1 and 5.0 nm. The thickness of these blocking layers may be:
at least 0.1 nm, at least 0.2 nm, at least 0.4 nm, or at least 0.5 nm, and/or
at most 5.0 nm, at most 3.0 nm.

Preferably, the blocking layer in contact with the titanium nitride layer has a thickness less than the thickness of the blocking layer which is not in contact with the titanium nitride layer.

According to the invention, a layer is considered to have a thickness smaller than the thickness of another layer if the difference in thickness is at least 0.2 nm, at least 0.5 nm, at least 1.0 nm, or at least 1.5 nm.

Preferably, the blocking layer in contact with the titanium nitride layer has a thickness:
at least 0.1 nm, at least 0.2 nm, at least 0.4 nm, or at least 0.5 nm, and/or
at most 2.0 nm, at most 1.5 nm, at most 1 nm.

It is considered that the “same” dielectric layer is located:
between the substrate and the first functional layer,
between each silver-based functional metallic layer,
above the final functional layer (the one furthest from the substrate).

“Dielectric coating” within the meaning of the present invention should be understood as meaning that there may be just one layer or several layers of different materials inside the coating. A “dielectric coating” according to the invention predominantly comprises dielectric layers. However, according to the invention, these coatings may also comprise layers of other natures, especially absorbent layers or metallic layers other than silver-based functional layers. For example, the coating furthest from the substrate may comprise a protective layer deposited in metal form.

According to the invention, the blocking layers do not form part of the dielectric coatings. This means that when the thickness of a dielectric coating is determined, the thickness of the blocking layers is not taken into consideration.

On the other hand, when the thickness of a dielectric coating is determined, the thickness of the titanium nitride layer is taken into account.

“Dielectric layer” within the meaning of the present invention should be understood as meaning that, from the perspective of its nature, the material is “nonmetallic”, that is, is not a metal. In the context of the invention, this term denotes a material having an n/k ratio, over the whole visible wavelength range (from 380 nm to 780 nm) of equal to or greater than 5. n denotes the real refractive index of the material at a given wavelength and k represents the imaginary part of the refractive index at a given wavelength; the ratio n/k being calculated at a given wavelength which is identical for n and for k.

The thickness of a dielectric coating corresponds to the sum of the thicknesses of the layers constituting it.

Preferably, the dielectric coatings have a thickness greater than 5 nm, between 10 and 200 nm, between 10 and 100 nm or between 10 and 70 nm.

The dielectric layers of the dielectric coatings exhibit the following characteristics, alone or in combination:
they are deposited by magnetic-field-assisted cathode sputtering,
they are selected from oxides or nitrides of one or more elements selected from titanium, silicon, aluminum, zirconium, tin and zinc,
they have a thickness of greater than 2 nm, preferably between 2 and 100 nm, between 5 and 50 nm, or between 5 and 30 nm.

According to one embodiment, the stack does not comprise a zinc oxide-based dielectric layer. These zinc oxide-based layers correspond to so-called stabilizing or wetting layers. Such zinc oxide-based layers may comprise at least 80% or 90% by mass of zinc, relative to the total mass of all the elements constituting the zinc oxide layer, excluding oxygen and nitrogen.

In all the stacks, the dielectric coating closest to the substrate is referred to as lower coating and the dielectric coating furthest from the substrate is referred to as upper coating. The stacks containing more than one silver layer also comprise intermediate dielectric coatings located between the lower coating and the upper coating.

The dielectric layers may have a barrier function. Dielectric layers having a barrier function (hereinafter barrier layer) is understood to mean a layer made of a material capable of forming a barrier to the diffusion of oxygen and water at high temperatures, originating from the ambient atmosphere or from the transparent substrate, toward the functional layer. Such dielectric layers are selected from:
layers comprising silicon and/or aluminum selected from oxides, nitrides and oxynitrides, optionally doped using at least one other element,
layers based on zinc tin oxide,
layers based on oxides of titanium and/or zirconium.

The dielectric coatings may comprise a dielectric layer comprising silicon and/or aluminum chosen from silicon and/or aluminum nitride- or oxynitride-based layers such as silicon nitride-based layers, aluminum nitride-based layers, silicon-aluminum nitride-based layers, silicon oxynitride-based layers, aluminum oxynitride-based layers and silicon-aluminum oxynitride-based layers.

Preferably, each dielectric coating comprises a dielectric layer comprising silicon and/or aluminum chosen from silicon and/or aluminum nitride- or oxynitride-based layers.

Preferably, the layers comprising silicon and/or aluminum are silicon and/or aluminum nitride-based layers.

The layers comprising silicon and/or aluminum may comprise, or consist of, elements other than silicon, oxygen and nitrogen. These elements may be selected from boron, titanium, hafnium and zirconium.

The layers comprising silicon may comprise at least 50%, at least 60%, at least 65%, at least 70%, at least 75.0%, at least 80%, or at least 90% by weight of silicon relative to the weight of all the elements forming the layer comprising silicon, other than nitrogen and oxygen.

Preferably, the layer comprising silicon comprises at most 35%, at most 20%, or at most 10% by weight of elements other than silicon relative to the weight of all the elements constituting the layer comprising silicon, other than oxygen and nitrogen.

According to one embodiment, the layers comprising silicon comprise less than 50%, less than 35%, less than 30%, less than 20%, less than 10%, less than 5% or less than 1% by weight of zirconium relative to the weight of all the elements constituting the layer comprising silicon, other than oxygen and nitrogen.

The layer comprising silicon may comprise at least 2.0%, at least 5.0%, at least 6.0% or at least 8.0% by weight of aluminum relative to the weight of all the elements constituting the layer based on silicon oxide, other than oxygen and nitrogen.

The layers comprising aluminum may comprise at least 50%, at least 60%, at least 65%, at least 70%, at least 75.0%, at least 80%, or at least 90% by weight of aluminum relative to the weight of all the elements constituting the layer comprising aluminum, other than nitrogen and oxygen.

According to the invention:
the layers based on silicon and/or aluminum nitride comprise essentially nitrogen and very little oxygen,
the layers based on silicon and/or aluminum oxynitride comprise a mixture of oxygen and nitrogen.

The amounts of oxygen and nitrogen in a layer are determined by atomic percentages relative to the total amounts of oxygen and nitrogen in the layer in question.

The layers based on silicon and/or aluminum nitride comprise at least 90%, as atomic percentage, of nitrogen relative to the oxygen and nitrogen in the layer based on silicon and/or aluminum nitride.

The layers based on silicon and/or aluminum oxynitride comprise 10 to 90% (limit values excluded), as atomic percentage, of nitrogen relative to the oxygen and nitrogen in the layer based on silicon and/or aluminum oxynitride.

The layers based on silicon nitride are preferably characterized by a refractive index at 550 nm of greater than or equal to 1.95.

The layers based on silicon oxynitride are preferably characterized by a refractive index at 550 nm which is intermediate between a non-nitrided layer of oxide and a non-oxidized layer of nitride. The layers based on silicon oxynitride preferably have a refractive index at 550 nm of greater than 1.55, 1.6 or 1.7 or of between 1.55 and 1.95, 1.6 and 2.0, 1.7 and 2.0 or 1.7 and 1.9.

These refractive indices may vary to a certain extent depending on the deposition conditions. Indeed, by altering certain parameters such as pressure or the presence of dopants, it is possible to obtain layers of greater or lesser density and therefore a variation in refractive index.

The layers comprising silicon may be layers of silicon and aluminum and/or zirconium nitride. These layers of silicon and aluminum and/or zirconium nitride may also comprise, by weight relative to the weight of silicon, aluminum and zirconium:
50 to 98%, 60 to 90%, 60 to 70% by weight of silicon,
2 to 10% by weight of aluminum,
0 to 30%, 10 to 30% or 15 to 27% by weight of zirconium.

The sum of the thicknesses of all the layers comprising silicon and/or aluminum in each dielectric coating is greater than or equal to 5 nm, greater than or equal to 8 nm, greater than or equal to 10 nm.

The sum of the thicknesses of all the layers comprising silicon and/or aluminum in the dielectric coating located below the silver-based functional layer is less than or equal to 30 nm, less than or equal to 25 nm, less than or equal to 20 nm, less than or equal to 15 nm.

The sum of the thicknesses of all the layers comprising silicon and/or aluminum in the dielectric coating located above the silver-based functional layer is greater than or equal to 15 nm, greater than or equal to 20 nm, greater than or equal to 30 nm, greater than or equal to 40 nm.

The dielectric coatings may comprise other layers than these layers comprising silicon and/or aluminum.

Preferably, the sum of the thicknesses of all the layers comprising silicon and/or aluminum in the dielectric coating located between the substrate and the first silver layer is greater than 50%, greater than 60%, greater than 70%, greater than 80% or greater than 90% of the total thickness of the dielectric coating.

Preferably, the sum of the thicknesses of all the layers comprising silicon and/or aluminum in each dielectric coating located above the first silver-based functional metallic layer is greater than 50%, greater than 60%, greater than 70%, greater than 75% or greater than 80% of the total thickness of the dielectric coating.

Preferably, the sum of the thicknesses of all the layers comprising silicon and/or aluminum in each dielectric coating is greater than 50%, greater than 60%, greater than 70% or greater than 75% of the total thickness of the dielectric coating.

Preferably, the sum of the thicknesses of all the layers comprising silicon and/or aluminum nitride-based silicon in the dielectric coating located between the substrate and the first silver layer is greater than 50%, greater than 60%, greater than 70%, greater than 75% or greater than 80% of the total thickness of the dielectric coating.

Preferably, the sum of the thicknesses of all the layers comprising silicon and/or aluminum nitride-based silicon and/or aluminum in each dielectric coating located above the first silver-based functional metallic layer is greater than 50%, greater than 60%, greater than 70%, or greater than 75% of the total thickness of the dielectric coating.

The stack of thin layers can optionally comprise a protective layer. The protective layer is preferably the final layer of the stack, that is to say the layer furthest from the substrate coated with the stack (before heat treatment).

According to this embodiment, the dielectric coating furthest from the substrate comprises a protective layer. These layers generally have a thickness of between 0.5 and 10 nm, between 1 and 5 nm, between 1 and 3 nm, or between 1 and 2.5 nm. This protective layer can be selected from a layer based on titanium, zirconium, hafnium, silicon, zinc and/or tin and a mixture thereof, this or these metals being in metal, oxidized or nitrided form.

According to one embodiment, the protective layer is based on zirconium and/or titanium oxide, preferably based on zirconium oxide, titanium oxide or titanium zirconium oxide.

When the thickness of a dielectric coating is determined, the thickness of the protective layer is taken into account.

Preferably, the sum of the thicknesses of all the oxide-based layers in the dielectric coating located between the substrate and the first silver layer is less than 20%, less than 10%, less than 5% or less than 2% of the total thickness of the dielectric coating.

Preferably, the sum of the thicknesses of all the oxide-based layers in the dielectric coating located above a silver-based functional layer is less than 20%, less than 10% or less than 8% of the total thickness of the dielectric coating.

Preferably, the sum of the thicknesses of all the oxide-based layers in each dielectric coating is less than 20%, less than 10%, or less than 8% of the total thickness of the dielectric coating.

The dielectric coating located between the substrate and the first functional metallic layer and/or each dielectric coating located above the first silver-based functional layer may consist solely of nitride layers, except for the upper protective layer.

According to one embodiment, the stack comprises:
a dielectric coating located below the silver-based functional metallic layer,
a blocking layer,
a silver-based functional metallic layer,
a blocking layer,
a dielectric coating located above the silver-based functional metallic layer, optionally comprising a protective layer.

According to one embodiment, the stack comprises:
a dielectric coating located below the silver-based functional metallic layer comprising a layer based on silicon and/or aluminum nitride,
a blocking layer,
a silver-based functional metallic layer,
a blocking layer,
a dielectric coating located above the silver-based functional metallic layer comprising a layer based on silicon and/or aluminum nitride and optionally a protective layer.

The substrate coated with the stack, or the stack alone, may be intended to undergo a heat treatment. The substrate coated with the stack may be bent and/or tempered. However, the present invention also relates to the coated substrate, not heat-treated.

The stack may not have undergone a heat treatment at a temperature of greater than 500° C., preferably 300° C. or 100° C.

The stack may have undergone a heat treatment at a temperature of greater than 300° C., preferably 500° C.

The heat treatments are selected from an annealing, for example from “Rapid Thermal Process” annealing, such as a laser or flash lamp annealing, a tempering and/or a bending. The rapid thermal annealing is for example described in application WO 2008/096089.

The heat treatment temperature (at the stack) is greater than 300° C., preferably greater than 400° C. and better still greater than 500° C.

The transparent substrates according to the invention are preferably made of a rigid inorganic material, such as made of glass, or are organic, based on polymers (or made of polymer).

The organic transparent substrates according to the invention can also be made of polymer, and are rigid or flexible. Examples of polymers which are suitable according to the invention comprise, especially:
polyethylene,
polyesters, such as polyethylene terephthalate (PET), polybutylene terephthalate (PBT) or polyethylene naphthalate (PEN);
polyacrylates, such as polymethyl methacrylate (PMMA);
polycarbonates;
polyurethanes;
polyamides;
polyimides;
fluorinated polymers, such as fluoroesters such as ethylene-tetrafluoroethylene (ETFE), polyvinylidene fluoride (PVDF), polychlorotrifluoroethylene (PCTFE), ethylene-chlorotrifluoroethylene (ECTFE), fluorinated ethylene-propylene copolymers (FEP);
photocrosslinkable and/or photopolymerizable resins, such as thiolene, polyurethane, urethane-acrylate, polyester-acrylate resins, and
polythiourethanes.

The substrate is preferably a sheet of glass or of glass-ceramic.

The substrate is preferably transparent, colorless (it is then a clear or extra-clear glass) or colored, for example blue, gray or bronze. The glass is preferably of soda-lime-silica type but it can also be a glass of borosilicate or alumino-borosilicate type.

According to a preferred embodiment, the substrate is made of glass, especially soda-lime-silica glass, or of polymer organic material.

The substrate advantageously has at least one dimension greater than or equal to 1 m, even 2 m and even 3 m. The thickness of the substrate generally varies between 0.5 mm and 19 mm, preferably between 0.7 and 9 mm, especially between 2 and 8 mm, even between 2.8 and 6 mm. The substrate may be flat or curved, indeed even flexible.

The invention also relates to a glazing comprising at least one material according to the invention. The invention relates to a glazing which may be in the form of a monolithic, laminated or multiple glazing, in particular double glazing or triple glazing.

A monolithic glazing comprises a material comprising a transparent substrate. Face 1 is outside the building and thus constitutes the exterior wall of the glazing and face 2 is inside the building and thus constitutes the interior wall of the glazing.

A multiple glazing comprises a material according to the invention and at least one additional substrate. The material and the additional substrate are either side by side or separated by at least one interlayer gas gap. The glazing provides a separation between an exterior space and an interior space.

A double glazing, for instance, comprises 4 faces; face 1 is outside the building and thus constitutes the exterior wall of the glazing, face 4 is inside the building and thus constitutes the interior wall of the glazing, faces 2 and 3 being inside the double glazing.

A laminated glazing comprises a material according to the invention and at least one additional substrate; the material and the additional substrate are separated by at least one lamination interlayer. A laminated glazing therefore comprises at least one structure of the material/lamination interlayer/additional substrate type. In the case of a laminated glazing, all the faces of the additional materials and substrates are numbered but the faces of the laminating interlayers are not numbered. Face 1 is outside the building and thus constitutes the exterior wall of the glazing, face 4 is inside the building and thus constitutes the interior wall of the glazing, and faces 2 and 3 are in contact with the lamination interlayer.

The lamination interlayer may especially be based on polyvinyl butyral PVB, ethylene vinyl acetate EVA, polyethylene terephthalate PET, polyvinyl chloride PVC. The stack of thin layers is positioned on one at least of the faces of one of the substrates.

A laminated and multiple glazing comprises a material according to the invention and at least two additional substrates corresponding to a second substrate and a third substrate,
the material and the third substrate are separated by at least one interlayer gas gap, and
the material and the second substrate or the second substrate and the third substrate are separated by at least one lamination interlayer.

These glazings may be assembled on a building or a vehicle.

The following examples illustrate the invention.

### EXAMPLES

### I. Descriptions of Materials

Stacks of thin layers defined below are deposited on substrates made of clear soda-lime glass with a thickness of 4 mm.

For these examples, the conditions of deposition of the layers deposited by sputtering (“magnetron cathode” sputtering) are summarized in table 1 below.

TABLE 1

| Table | Targets employed | Pressure μbar | Gas |
|---|---|---|---|
| Si₃N₄ | Si:Al 92/8% by wt | 2-7 | Ar 60%—O₂ 40% |
| TiN | Ti | 1-10 | Ar 85%—N2 15% |
| NiCr | Ni:Cr (80:20% at.) | 2 | Ar at 100% |
| Ag | Ag | 6 | Ar at 100% |
| TiO₂ | TiOx | 2 | Ar 88%—O₂ 12% |

at.: atomic; wt: weight; *: at 550 nm.

The materials and the physical thicknesses in nanometers (unless otherwise indicated) of each layer or coating of which the stacks are composed are listed in table 2 below as a function of their positions with regard to the substrate bearing the stack.

TABLE 2

| Materials | | Cp-1 | Cp-2 | Cp-3 | Cp-4 | Inv-1 | Inv-2 | Inv-3 |
|---|---|---|---|---|---|---|---|---|
| DC | TiO₂ | 1 | 1 | 4 | 1 | 1 | 4 | 1 |
| | Si₃N₄ | 46 | 46 | 46 | 46 | 46 | 46 | 46 |
| | TiN | — | — | — | 13.52 | 8.5 | 8 | — |
| BL | NiCr | 2.5 | 2.5 | 2.5 | — | 0.8 | 1.3 | 2.5 |
| FL | Ag | 13 | 15.5 | 10 | 13 | 13 | 10 | 13 |
| BL | NiCr | 2.5 | 2.5 | 2.5 | 2.5 | 2.5 | 1.3 | 0.8 |
| DC | TiN | — | — | — | — | — | — | 9 |
| | Si₃N₄ | 12 | 12 | 9 | 12 | 12 | 9 | 12 |

Substrate: glass
DC: Dielectric coating; BL: Blocking layer; FL: Functional layer

### II. Energy Performance: First Series

Table 3 below lists the optical and energy performance levels of the materials of the examples Cp-1, Cp-2, Cp-4, Inv-1 and Inv-2 in double glazing form. The double glazing has a configuration: 6-16(Ar-90%)-4, that is to say a configuration made up of a material comprising a substrate of ordinary soda-lime glass type of 4 mm and another glass substrate of soda-lime glass type of 4 mm, the two substrates are separated by an interlayer gas gap formed of 90% argon and 10% air with a thickness of 16 mm. The stacks are positioned on face 2. The material coated with the stack was not subjected to heat treatment. These results were obtained by simulation.

TABLE 3

| Table 3 | Cp-1 | Cp-2 | Cp-4 | Inv-1 | Inv-3 |
|---|---|---|---|---|---|
| TL % | 42 | 40 | 43 | 42 | 43 |
| a* (T) | −3.12 | −3.38 | −2.61 | −3.04 | −3.79 |
| b* (T) | −1.13 | −1.07 | 1.76 | 1.99 | −1.31 |
| Rext % | 28 | 31 | 31 | 31 | 25 |
| a* (Rext) | −1.42 | −0.91 | −3.99 | −3.09 | −2.06 |
| b* (Rext) | −11.63 | −9.83 | −7.76 | −9.60 | −2.94 |
| Rint % | 11 | 12 | 11 | 12 | 11 |
| a* (Rint) | 7.72 | 8.32 | 1.09 | 4.23 | 7.54 |
| b* (Rint) | −11.47 | −11.28 | −12.29 | −14.25 | −7.27 |
| g-value | 0.34 | 0.32 | 0.33 | 0.32 | 0.33 |
| s | 1.24 | 1.28 | 1.29 | 1.30 | 1.32 |

The comparative example Cp-1 shows the state of the art.

Example Inv-1 according to the invention has a light transmission equivalent to that of Cp-1. Its selectivity is higher than that of Cp-1 (+0.06).

This shows the advantage of the invention.

Example Inv-3 according to the invention has a light transmission equivalent to that of Cp-1. Its selectivity is higher than that of Cp-1 (+0.08). This shows the advantage of the invention.

Example Cp-2 shows that these advantageous results are not obtained using a thicker silver layer. Example Cp-2 comprises the same dielectric layers and blocking layers (natures and thicknesses) and a thicker silver layer than the comparative example Cp-1. This material has a lower light transmission and a higher external reflection than those of example Cp-1. Its selectivity is however improved relative to Cp-1 (Cp-1=1.24 and Cp-2=1.28) but remains lower than that of example 1 (Inv-1=1.30 and Cp-2=1.28). Increasing the amount of silver makes it possible to partially compensate for the selectivity but at the price of a lower light transmission.

Example Cp-4 comprising only a titanium nitride layer in contact with the functional layer has an improved selectivity. However, the selectivity remains less advantageous than that obtained with the examples according to the invention. But most importantly, such a material remains extremely scratchable. The presence of a metal blocking layer as claimed between the titanium nitride layer and the silver layer is essential in order to obtain satisfactory scratch resistance.

This shows that the introduction of a titanium nitride layer in contact with a blocking layer has a beneficial effect on the energy performance of the glazing. This beneficial effect cannot be obtained by adjusting the thickness of the silver layer.

### II. Energy Performance: Second Series

These results were obtained on prototypes, that is to say that the corresponding glazings have actually been manufactured.

Table 4 lists the optical and energy performance of the materials covered by the examples:
DGU-Cp-3 and DGU-Inv-2: double glazing in a 6-16(Ar-90%)-4 configuration with the stack positioned on face 2, the substrate bearing the stack has not undergone a high-temperature heat treatment,
DGU TT-Cp-3 and DGU TT-Inv-2: double glazing in a 6-16(Ar-90%)-4 configuration with the stack positioned on face 2, the substrate bearing the stack has undergone a high-temperature heat treatment.
Laminated-Cp-3 and Laminated-Inv-2: laminated glazing in a 4 mm Substrate/0.38 mm PVB Interlayer/4 mm Substrate configuration with the stack positioned on face 2, the substrate bearing the stack has not undergone a high-temperature heat treatment.

The high-temperature heat treatment is carried out as follows:
rise in temperature to 700° C. in 300-350 s,
remaining at 700° C. for 30-50 s,
lowering the temperature in 100-150 s.

TABLE 4

| | DGU | | DGU TT | | Laminated | |
|---|---|---|---|---|---|---|
| | Cp-3 | Inv-2 | Cp-3 | Inv-2 | Cp-3 | Inv-2 |
| TL % | 42.3 | 43.0 | 43.5 | 47.2 | 42.6 | 44.7 |
| a* (T) | −3.5 | −2.9 | −3.0 | −3.5 | −2.9 | −3.1 |
| b* (T) | 1.1 | 2.9 | 0.7 | 2.3 | −2.1 | −0.4 |
| Rext % | 29.5 | 31.5 | 27.0 | 29.8 | 26.6 | 27.0 |
| a* (Rext) | −4.0 | −5.1 | −4.5 | −4.3 | −1.5 | −1.5 |
| b* (Rext) | −8.7 | −7.4 | −8.5 | −8.4 | −1.5 | −1.1 |
| Rint % | 10.6 | 11.3 | 10.2 | 12.7 | 10.5 | 9.4 |
| a* (Rint) | 5.2 | 0.8 | 3.4 | 0.0 | 3.2 | 2.6 |
| b* (Rint) | −15.9 | −14.1 | −14.7 | −14.4 | −3.4 | −0.6 |
| g-value | 0.342 | 0.342 | 0.354 | 0.357 | 0.403 | 0.402 |
| s | 1.24 | 1.26 | 1.23 | 1.32 | 1.06 | 1.11 |

In all cases, an improvement in selectivity is observed in the case of the invention. The effect on selectivity is more pronounced on tempered or laminated glazings.

It is also observed that the use of a titanium nitride layer, in addition to its influence on the tempered and laminated energy configuration, also partially neutralizes the internal reflection color of the glazings.

1. A material comprising a transparent substrate coated with a stack comprising at least one silver-based functional metallic layer and at least two dielectric coatings, each dielectric coating including at least one dielectric layer, so that each silver-based functional metallic layer is positioned between two dielectric coatings, wherein the stack comprises:
two blocking layers located in contact, below and above, with one of the at least one silver-based functional metallic layer, the two blocking layers being chosen from metallic layers based on a metal or a metal alloy of one or more elements chosen from titanium, nickel, chromium, tantalum, zirconium and niobium,
a titanium nitride layer located in contact with one of the two blocking layers and separated from the one of the at least one silver-based functional layer by said one of the two blocking layers.

2. The material according to claim 1, wherein the titanium nitride layer is located above the one of the at least one silver-based functional layer.

3. The material according to claim 1, wherein the titanium nitride layer has a thickness greater than or equal to 2 nm.

4. The material according to claim 1, wherein the titanium nitride layer has a thickness of between 5 and 15 nm.

5. The material according to claim 1, wherein the one of the two blocking layers in contact with the titanium nitride layer has a thickness less than a thickness of the other one of the two blocking layers which is not in contact with the titanium nitride layer.

6. The material according to claim 1, wherein the two blocking layers each have a thickness of between 0.1 and 5.0 nm.

7. The material according to claim 1, wherein each dielectric coating comprises a dielectric layer comprising silicon and/or aluminum selected from layers based on silicon and/or aluminum nitride or oxynitride.

8. The material according to claim 1, the wherein a sum of the thicknesses of all layers comprising silicon and/or aluminum in each dielectric coating is greater than 50% of a total thickness of the dielectric coating.

9. The material according to claim 1, the wherein a sum of thicknesses of all oxide-based layers in each dielectric coating is less than 20% of a total thickness of the dielectric coating.

10. The material according to claim 1, wherein the dielectric coating furthest from the transparent substrate comprises a protective layer chosen from a layer based on titanium, zirconium, hafnium, silicon, zinc and/or tin and mixtures thereof, metals which is/are in metallic, oxidized or nitrided form.

11. The material according to claim 1, wherein the transparent substrate coated with the stack is bent and/or tempered.

12. The material according to claim 1, wherein the transparent substrate is made of glass or of polymer organic material.

13. A glazing comprising a material according to claim 1, wherein the glazing is a monolithic, laminated and/or multiple glazing.

14. The glazing according to claim 13, wherein the glazing is a multiple glazing and comprises a material and at least one additional substrate, the material and the additional substrate being separated by at least one interlayer gas gap.

15. The glazing according to claim 14, wherein the glazing is a laminated glazing and comprises a material and at least one additional substrate, the material and the additional substrate being separated by at least one lamination interlayer.

16. The material according to claim 12, wherein the glass is soda-lime-silica glass.
